(19) United States
(12) Patent Application Publication
(10) Pub. No.: US 2005/0036623 A1
(43) Pub. Date: Feb. 17, 2005

(54) Methods and apparatus for distribution of global encryption key in a wireless transport network

(76) Inventors: Ming-Jye Sheu, San Jose, CA (US); Ted Tsei Kuo, Palo Alto, CA (US); Tyan-Shu Jou, Cary, NC (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/918,005

(22) Filed: Aug. 13, 2004

Related U.S. Application Data
(60) Provisional application No. 60/495,185, filed on Aug. 15, 2003.

(51) Int. Cl. H04L 9/00

(52) U.S. Cl. 380/270

(57) ABSTRACT

A method of providing encryption service in a wireless transport network comprises the step of designating a first wireless device as a global encryption key server to create and maintain the global encryption key for a wireless transport network encryption. Nest step is to distribute the global encryption key from the first wireless device to a second wireless device in the wireless transport network. The existing global encryption key in the second wireless device is replaced by the global encryption key. Further step is to transit an expiring global encryption key to a new global encryption key in the wireless transport network without traffic loss and security.

### CROSS-REFERENCE TO RELATED APPLICATIONS

This application claims the benefit of U.S. provisional application serial No. 60/495185, filed on Aug. 15, 2003, which provisional application is hereby incorporated by reference.

The present invention is also related to co-pending application serial number ______, filed on Aug. 10, 2004, under Express Mail Label No. EV547998129US and entitled “Methods and Apparatus for Broadcast Traffic Reduction on a Wireless Transport Network”. The co-pending application is incorporated herein for reference.

### FIELD OF THE INVENTION

The present invention relates to wireless communications systems, more particular, to a wireless transport network system that is capable of distribution of global encryption key in a wireless network.

### BACKGROUND OF THE INVENTION

Typical wireless network systems comprise one or more access devices for communication purposes. The users may be communicated with the access device with personal computers or notebook computers via wireless means. Wireless local area networks (WLANs) were originally intended to allow wireless connections to a wired local area network (LAN), such as where premises wiring systems were nonexistent or inadequate to support conventional wired LANS. WLANs are often used to service mobile computing devices, such as laptop computers and personal digital assistants (PDAs). Typically, Access Points (APs) are set to ensure adequate radio coverage throughout the service area of the WLAN, while minimizing the costs associated with the installation of each AP. The APs must be configured to eliminate coverage gaps and to provide adequate coverage.

A wireless transport network is a network comprises a plurality of wirelessly connected devices that are responsible for relaying traffic for associated mobile clients. An example of a wireless transport network is a plurality of IEEE 802.11 capable devices that provide transport service for IEEE 802.11 or Bluetooth capable clients such as laptop computers, PDA (personal digital assistant), and the like. The network can further comprise one or more connections to a wired network through one or multiple edge devices. The edge devices are equipped and capable of both wireless and wired communication.

In a wireless transport network, confidentiality and authenticity of data traffic is most important. The transmission domain (the air) by nature is not secured and therefore encryption is essential in any wireless transport networks. Pair-wise encryption/decryption between every neighboring wireless network device of a wireless transport network is inefficient and time-consuming if hardware-assist encryption and decryption is not available. A data frame that leaves from one wireless device from one end of a wireless transport network to the other end of the same network might need several encryptions and decryptions before it reaches its final destination. Furthermore, a group key for a broadcast or a multicast data frame is still needed in addition to pair-wise encryption keys. A more efficient and easy-to-manage encryption/decryption scheme in a wireless transport network is to use a global encryption key for wireless transport network encryption service. Once a data frame from client mobile station enters a wireless transport network, it is encrypted only once until it reaches the exit wireless device, where it would be decrypted once.

Furthermore, in a wireless transport network, wireless devices might be temporary out of service, resulting in separated network segments. Each of the network segments might have a different global encryption key, which is used in the confine of the segment. When network segments are joined by a new wireless device, a new global encryption key is needed. The invention is particularly concerned with deploying a unique global encryption key for wireless devices that form a wireless transport network and with several wireless transport network segments that are joined by a new wireless device.

### SUMMARY OF THE INVENTION

The purpose for the present invention is to provide an encryption key distribution method in a wireless transport network. A plurality of wireless transport devices and at least one edge device are needed in the network.

The method of providing encryption service in a wireless transport network comprises the step of designating a first wireless device as a global encryption key server to create and maintain the global encryption key for a wireless transport network encryption. Next step is to distribute the global encryption key from the first wireless device to a second wireless device in the wireless transport network. The existing global encryption key in the second wireless device is replaced by the global encryption key. Further step is to transit an expiring global encryption key to a new global encryption key in the wireless transport network without traffic loss and security.

The method further includes a step of selecting a new designated global encryption key server in the case of failure of the designated global encryption key server in the wireless transport network. A step of selecting a new designated global encryption key server is performed in the case of failure of the designated global encryption key server in the wireless transport network. Re-selecting a designated global encryption key server is employed when the failed designated global encryption key server recovers.

The present invention discloses a wireless device capable of distributing a global encryption key in a wireless transport network. The device includes a processing unit and memory. The wireless device includes a wireless transport device. The device also includes means for authenticating coupled to the processing unit to authenticate another wireless device (such as another wireless transport device) in separated network segments of the wireless transport network, and means for selecting is coupled to the processing unit for selecting a global encryption key among the separate network segments for global encryption key distribution. Means for distributing is coupled to the processing unit to distribute the global encryption key. Means for decrypting/re-encrypting is also coupled to the processing unit for performing decrypting/re-encrypting in the wireless transport network until all the separate network segments use the global encryption key.

### BRIEF DESCRIPTION OF THE DRAWINGS

FIG. 1 illustrates an example of a wireless transport network.

FIG. 2 is a flow chart of the present invention.

FIG. 3 shows a block diagram according to the present invention.

### DETAILED DESCRIPTION OF THE PREFERRED EMBODIMENT

The present invention provides a method and a means for providing secured communication in a wireless transport network. The invention provides a method to create, maintain, and distribute global encryption key to all wireless devices in a wireless transport network. The invention provides a means for a wireless device to join segments of a wireless transport network with different global encryption keys to a seamlessly integrated wireless transport network with a single global encryption key.

Wireless Transport Network

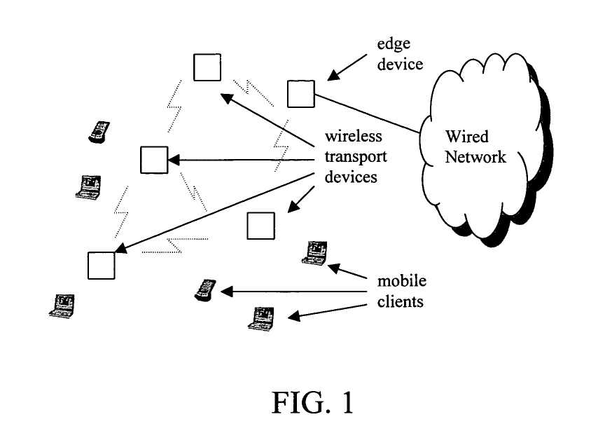

FIG. 1 illustrates a communication network including at least one edge device. The wired LAN's could be joined by the edge device, bridges and access points or base stations (not shown). The present invention further includes a plurality of wireless transport devices coupled to the edge devices by wireless networking. The wireless transport devices are capable of relaying the broadcast frame on the wireless network. The edge devices are also equipped and capable of both wireless and wired communication. This arrangement can not be found in the prior art. Each edge device communicates with a wireless transport device, and the wireless transport devices communicate to the other neighbor device, such as one or more mobile terminals (clients) or other neighboring wireless transport devices. Please refer to FIG. 1, a wireless transport network includes a plurality of IEEE 802.11 capable devices that provide transport service for IEEE 802.11 or Bluetooth capable clients such as laptop computers, PDA (personal digital assistant) or the like. The network can further comprise one or more connections to a wired network through one or multiple edge devices.

As illustrated in FIG. 1, all of the wireless transport devices may forward broadcast frame via wireless network to other mobile client or wireless transport device. The present invention is not directed to controlling the path of the transmission but is concerned with encryption and/or decryption service in the wireless network. The wireless transport device includes a table with the information that contains the neighboring device from which a broadcast frame originated from a particular wireless transport device can be received. Therefore, a wireless network includes at least one edge device that coupled between wired LAN and wireless LAN. At least one wireless transport device is coupled to the edge device and the at least one mobile device via the wireless network. The devices may construct a segment of the wireless transport network.

Method of Providing Encryption Service

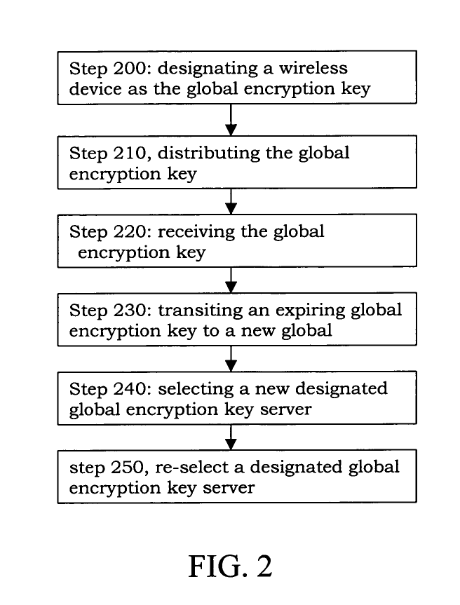

The novel aspect according to the present invention is a method of providing encryption service in a wireless transport network. Please refer to FIG. 2, the method includes an initial step 200 of designating a wireless device as the global encryption key server that creates and maintain global encryption key for wireless transport network encryption. The wireless device could be any portable wireless device, the wireless transport device or the edge device. The devices mentioned above thereby constructing a segment of the wireless transport network. Subsequently, please refer to step 210, the global encryption key is distributed from the global encryption key generator (the designated wireless device) to all other wireless devices in the same wireless transport network. After the device received the global encryption key, in step 220, the device will perform a subsequent process to replace an existing global encryption key to a new key, namely the current received global encryption key. Next, the device transits an expiring global encryption key to a new global encryption key in the same wireless transport network without traffic loss and security shown in step 230 of the FIG. 2.

The further step in accordance with the above method includes the step (240) of selecting a new designated global encryption key server by the user, controller or network service provider in the case of temporary failure of the designated global encryption key server in a wireless transport network, please refer to FIG. 2. Then, the system service provider may, step 250, re-select a designated global encryption key server when the failed designated global encryption key server recovered.

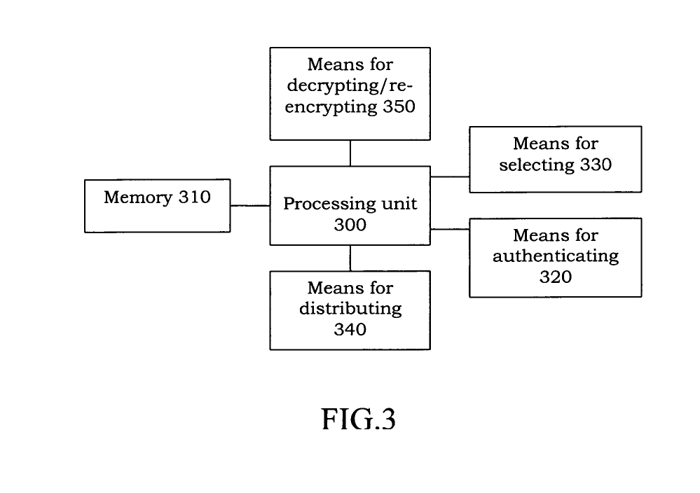

Please refer to FIG. 3, in order to perform such function mentioned above, the wireless device need to implement a mechanism or means of joining global encryption keys of several separated network segments in a wireless transport networks. The means or mechanism includes a processing unit 300 and memory 310. Means of authenticating 320 is coupled to the processing unit 300 to authenticate other wireless devices in separated network segments of the wireless transport network. A selecting means 330 is coupled to the processing unit 300 for selecting a new global encryption key among separate network segments with substantially less overhead for the new global encryption key distribution. Means for distributing 340 is also coupled to the processing unit 300 to distribute new global encryption key to necessary separated network segments. A means for decrypting/re-encrypting 350 is coupled to the processing unit 300 for performing decrypting/re-encrypting between separate network segments in a wireless transport network until all segments use the new global encryption key.

Therefore, the present invention provides the unique global encryption key for wireless devices that form a wireless transport network and with several wireless transport network segments that are joined by a new wireless device.

It will be appreciated that the preferred embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method of providing encryption service in a wireless transport network comprising:
designating a first wireless device as a global encryption key server to create and maintain said global encryption key for a wireless transport network encryption;
distributing said global encryption key from said first wireless device to a second wireless devices in said wireless transport network; and
replacing an existing global encryption key in said second wireless device to said global encryption key.

2. The method of claim 1, further comprising a step of transiting an expiring global encryption key to a new global encryption key in said wireless transport network.

3. The method of claim 1, further comprising a step of selecting a new designated global encryption key server in the case of failure of said designated global encryption key server in said wireless transport network.

4. The method of claim 3, further comprising a step of re-selecting a designated global encryption key server when said failed designated global encryption key server recovers.

5. The method of claim 2, further comprising a step of selecting a new designated global encryption key server in the case of failure of said designated global encryption key server in said wireless transport network.

6. The method of claim 5, further comprising a step of re-selecting a designated global encryption key server when said failed designated global encryption key server recovers.

7. The method device of claim 1, wherein said first wireless device includes a wireless transport device that is capable of relaying a broadcast frame on said wireless transport network.

8. The method device of claim 1, wherein said second wireless device includes a wireless transport device that is capable of relaying a broadcast frame on said wireless transport network.

9. The method device of claim 1, wherein said first device and said second device construct a segment of said wireless transport network.

10. A wireless device capable of distributing a global encryption key in a wireless transport network comprising:
a processing unit and memory;
means for authenticating coupled to said processing unit to authenticate other wireless device in separated network segments of said wireless transport network;
means for selecting coupled to said processing unit for selecting a global encryption key for global encryption key distribution;
means for distributing coupled to said processing unit to distribute said global encryption key;
means for decrypting/re-encrypting coupled to said processing unit for performing decrypting/re-encrypting in said wireless transport network.

11. The wireless device of claim 10, wherein said wireless device includes a wireless transport device that is capable of relaying a broadcast frame on said wireless transport network.

12. The wireless device of claim 10, wherein said other wireless device includes a wireless transport device that is capable of relaying a broadcast frame on said wireless transport network.

13. The method device of claim 10, wherein said first device and said second device construct a segment of said wireless transport network.
